(19) United States
(12) Patent Application Publication
(10) Pub. No.: US 2026/0025542 A1
(43) Pub. Date: Jan. 22, 2026

(54) SYSTEMS AND METHODS FOR CONTENT PRESENTATION IN MULTI-DWELLING UNITS

(71) Applicant: DISH Network L.L.C., Englewood, CO (US)

(72) Inventors: Ryan Burr Scribner, Erie, CO (US); Aaron William Schwartz, Denver, CO (US); Clark Hurst Pendery, Englewood, CO (US); Jason Anthony Madruga, Castle Rock, CO (US); Joshua David Wade, Castle Rock, CO (US)

(21) Appl. No.: 18/779,738

(22) Filed: Jul. 22, 2024

(51) Int. Cl. H04N 21/258; H04N 21/472

(52) U.S. Cl. CPC H04N 21/25841; H04N 21/25891; H04N 21/472

(57) ABSTRACT

A multi-dwelling content presentation system is described herein. The system may detect that a user device for a user is within a geographic area associated with an organization. The system may identify a set of access points associated with a network used by the organization and may detect whether the user device has connected to at least one access point of the set of access points. The system may determine whether the user of the user device was present at one or more locations within the geographic area based on the connection of the user device to the at least one access point. The system may identify content based on the determination of whether the user was present at the one or more locations and may cause a content presentation device to display the identified content.

### BACKGROUND

Various organizations, such as hotels, motels, hostels, cafes, or other organizations (collectively “Multiple Dwelling Units” or “MDUs”) that provide access to content to their patrons, provide access to Internet content, television content, or other content to their patrons. It is with respect to this and other considerations that the embodiments described herein have been made.

### BRIEF SUMMARY

The embodiments disclosed herein improve technology that provides a user with access to content when a user's device is present at a geographic location associated with an organization by providing a technical solution that detects a location of the user device within the geographic location and identifies content to be presented to the user device. The embodiments disclosed herein may cause a content presentation device associated with the organization to display content that a user of the user device was previously viewing. The embodiments disclosed herein may cause a device associated with an amenity offered by the organization to be configured based on one or more preferences of a user of the user device.

In some embodiments, an MDU content presentation system determines whether a user of the user device was present at one or more locations within a geographic area based on a determination that the user device was connected to at least one access point. In such embodiments, the MDU content presentation system may identify one or more access points associated with each location of the one or more locations.

In some embodiments, an MDU content presentation system configures one or more devices associated with an amenity offered by the organization by transmitting a signal to the at least one device instructing the at least one device to be configured based on the historical data indicating user preferences. In some embodiments, the MDU content presentation system identifies one or more configurations of one or more smart devices associated with the user to configure the one or more devices associated with the amenity.

In some embodiments, to detect that the user device associated with the user is within a geographic area associated with an organization, the MDU content presentation system determines whether the user device has scanned one or more physical codes associated with the organization. In some embodiments, the MDU content presentation system detects that the user device is within the geographic area based on a determination that the user device has interacted with a device equipped with a near-field-communication chip.

In some embodiments, the MDU content presentation system causes a content presentation device associated with one or more amenities to receive instructions to display the content based on a determination that a user device has connected to an access point associated with the one or more amenities. The MDU content presentation system may cause the content presentation device to display the content by transmitting instructions to the content presentation device.

### BRIEF DESCRIPTION OF THE DRAWINGS

FIG. 1 is a display diagram of an example environment in which an MDU content presentation system may operate, according to various embodiments described herein.

FIG. 2 is a block diagram of an MDU content presentation system, according to various embodiments described herein.

FIG. 3 is a flow diagram of a process for presenting content to a user, according to various embodiments described herein.

FIG. 4 is a flow diagram of a process for determining whether a user device was present in one or more geographic areas, according to various embodiments described herein.

FIG. 5 is a flow diagram of a process to configure one or more devices based on historical user data, according to various embodiments described herein.

FIG. 6 is a flow diagram of a process to display content previously viewed by a user on a content presentation device, according to various embodiments described herein.

### DETAILED DESCRIPTION

Organizations, such as hotels, motels, hostels, cafes, or other organizations (collectively “Multiple Dwelling Units” or “MDUs”), typically provide content to their patrons via content presentation devices associated with the respective organization. Such organizations offer amenities to their patrons and may provide content to patrons regarding those amenities. Conventional systems that provide such content typically provide the content randomly, or in accordance with a predetermined order, without first determining whether the content is relevant to the patron. Furthermore, conventional systems are not able to configure amenities, or aspects of amenities, based on a patron's preference. Conventional systems are further unable to detect whether a patron had viewed content in the past and to automatically present the previously viewed content to the patron.

The embodiments disclosed herein improve technology that provides users with content when the users are a patron of an organization by providing a technical solution that detects a location of the user device within a geographic location associated with the organization and identifies content to be presented to the user devices. The embodiments disclosed herein may also determine whether a user is present at the geographic location and an area within the geographic location within which the user is present. The embodiments disclosed herein may cause a content presentation device associated with the organization to display content that a user of the user device was previously viewing. The embodiments disclosed herein may cause a device associated with an amenity offered by the organization to be configured based on one or more preferences of a user of the user device.

Unless the context requires otherwise, throughout the specification and claims which follow, the word “comprise” and variations thereof, such as, “comprises” and “comprising” are to be construed in an open, inclusive sense, for example “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments, and references to “some embodiments,” “other embodiments,” “example embodiments,” “one embodiment,” “an embodiment,” etc., do not preclude the combination of the particular features, structures, or characteristics of any of the embodiments with any of the other embodiments described herein.

Throughout this specification and the claims, references to causing a device, such as a computing device or other device, to perform an action, execute instructions, receive data, transmit data, or be affected in some manner, may be made. One of ordinary skill in the art may recognize that a device may cause a second device to be affected in any of the manners listed above by transmitting instructions to the second device, transmitting data to the second device, transmitting instructions or data to a third device that can communicate with the second device, presenting instructions to a user to affect the second device, take other actions that affect the second device, or some combination thereof. In the embodiments described herein, any one or more of these methods may be used to cause a second device to be affected in some manner.

As used in this specification and the appended claims, the singular forms “a,” “an,” and “the” include plural referents unless the content clearly dictates otherwise. The term “or” is generally employed to include “and/or” unless the content clearly dictates otherwise. The term “and/or” is generally employed to include an inclusive or.

The headings and Abstract of the Disclosure provided herein are for convenience only and do not interpret the scope or meaning of the embodiments.

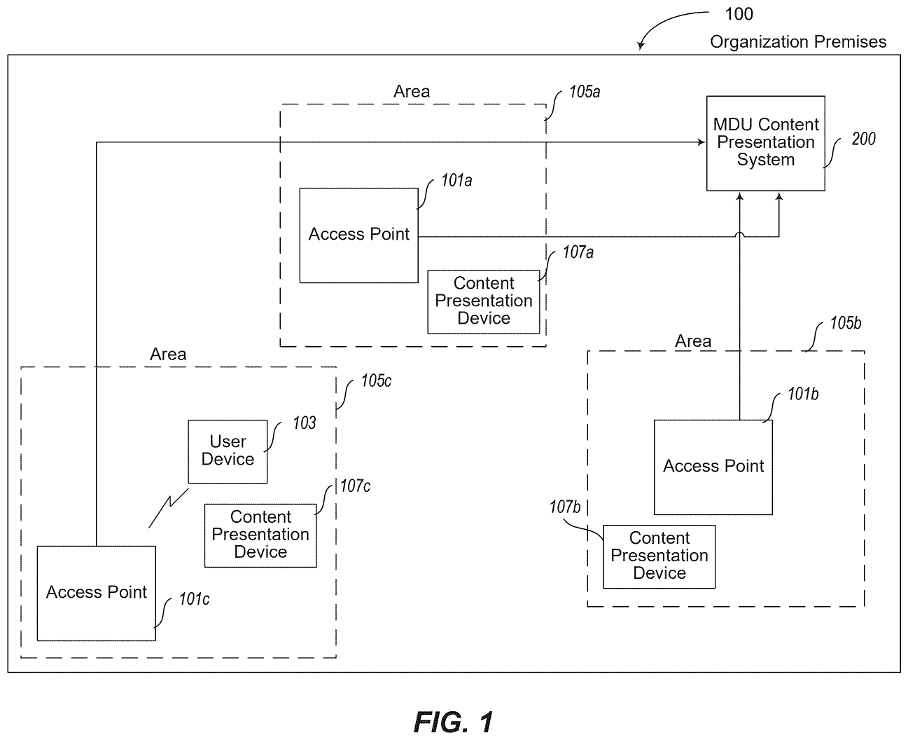

FIG. 1 is a display diagram of an example environment 100 in which an MDU content presentation system may operate, according to various embodiments described herein. The environment 100 may represent a geographic area within which an organization is located, such as the premises of the organization. The environment 100 includes an MDU content presentation system 200 (the “system 200”), one or more access points 101a-101c (collectively “access points 101” or individually as “access point 101”), a user device 103, one or more areas within an organization 105a-105c (collectively as “areas 105” or individually as “area 105”), and one or more content presentation devices 107a-107c (collectively as “content presentation devices 107” or individually as “content presentation device 107”). In some embodiments, one or more of the areas 105 include an amenity device (not shown), such as a content presentation device to which access is provided as part of the amenity, a smart device to which access is provided as part of the amenity, a device used by a provider of the amenity, or other devices associated with an amenity.

The access points 101 may be one or more devices that provide user devices, such as the user device 103; content presentation devices, such as the content presentation devices 107; the system 200; smart devices (not shown); other devices; or a combination thereof, with access to a wired or wireless network associated with the organization. The network associated with the organization may be a network, communication system, or networked system (not shown), to which the system 200, content presentation devices 107, access points 101, and user device 103, may be coupled. Non-limiting examples of such a network or communication system include, but are not limited to, an Ethernet system, twisted pair Ethernet system, an intranet, a local area network (LAN) system, short range wireless network (e.g., Bluetooth®), a personal area network (e.g., a Zigbee network based on the IEEE 802.15.4 specification), a Consumer Electronics Control (CEC) communication system, Wi-Fi, satellite communication systems and networks, cellular networks, cable networks, or the like.

The content presentation devices 107, user device 103, or some combination thereof, may be one or more endpoint devices, such as televisions, projectors, PCs, tablets, laptop computers, smartphones, personal assistants, drones, Internet connection devices, vehicles, satellite antennas, other antennas, fleet tracking devices, USB dongles, Mi-Fi devices, customer premises equipment (“CPE”), wireless LAN, Wi-Fi, Worldwide Interoperability for Microwave Access (WiMax) devices, or the like, and may be communicatively coupled to the network or to each other so that the plurality of endpoint devices are communicatively coupled together. The content presentation devices 107 may be communicatively coupled to a network via interaction with an access point 101. The content presentation devices 107 may transmit, receive, or some combination thereof, content pages from a content page management system (not shown) that provides one or more content pages to content presentation devices. In some embodiments, the content page management system communicates with, is included in, or is otherwise accessible by the system 200. In some embodiments, a content presentation device 107 is able to communicate with one or more content providers (not shown) to receive content that is presented to a user of the content presentation device 107.

In an example embodiment, at least some of the content presentation devices may be television sets located within the rooms of an organization such as a hotel. The organization may configure the content presentation devices to display one or more content pages that provide a patron of the hotel that accesses the content presentation device with content, information regarding content, etc. For example, the content page may be configured to provide the patron with information regarding the weather, events occurring in a geographical area within which the hotel is located, content provided by one or more television networks, access to one or more streaming services, information regarding the hotel, such as a room service menu, concierge information, or other hotel information, other content that a patron of a hotel may access, or some combination thereof.

The areas 105 may be or represent one or more areas within a geographic area associated with the organization. Examples of such areas may include a room provided to a patron, a pool area, a fitness area, a restaurant, a coffee shop, a lobby area, a dining area, a business center area, a conference area, a recreation area, a gambling area, other areas within the geographic area associated with the organization, or some combination thereof. Each of the areas 105 may be associated with one or more amenities provided by the organization to one or more patrons. Furthermore, each of the areas 105 may include one or more smart devices (not shown) that may be associated with the one or more amenities. For example, the smart devices may be smart lights, smart thermostats, smart cooking implements, smart cleaning devices, drones, robots, smart clocks, other “Internet-of-things” devices, other devices able to communicate with various devices, or some combination thereof. In some embodiments, one or more smart devices associated with an area 105 may be controlled by an MDU content presentation system, such as the system 200. In some embodiments, one or more of the smart devices may be controlled by a user device, such as the user device 103. In some embodiments, at least one area 105 includes a physical code (not shown) that may be scanned by a user device, such as the user device 103.

In an example embodiment, the MDU content presentation system 200 detects that a user device, such as the user device 103, is within a geographic area within which an organization is located, such as area 105c of the organization premises depicted in the environment 100. In such an example, the MDU content presentation system 200 may record a location of the user device 103 within the environment 100 based on the connection of the user device 103 with one or more access points, such as the access points 101. For example, one or more of the access points 101 may be logically associated, mapped, or otherwise associated with one or more areas. In such an example, connection to an access point associated with an area may indicate that the user device is located in the area. Continuing the example, the MDU content presentation system 200 may identify content to present to the user of the user device based on the access points to which the user device connected and one or more areas, such as the areas 105, associated with the access points.

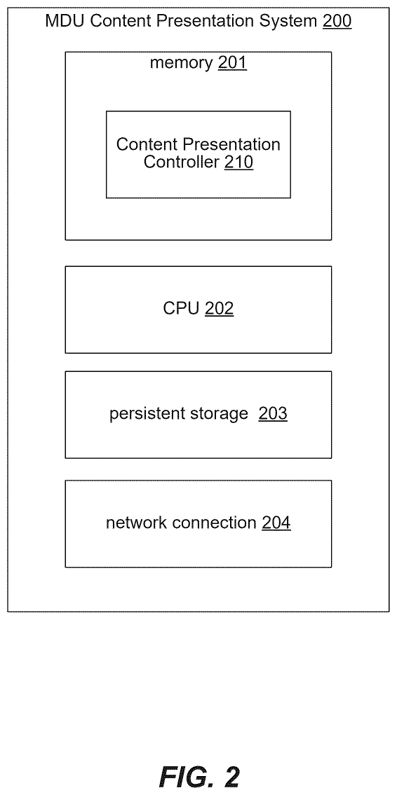

FIG. 2 is a block diagram of an MDU content presentation system 200, according to various embodiments described herein. One or more aspects of the MDU content presentation system 200 may be implemented or integrated on or in a content presentation device (such as a content presentation device 107), access point (such as the access point 101), user device (such as the user device 103), one or more devices, one or more servers, or some combination thereof.

In various embodiments, the system 200 includes one or more of the following: a computer memory 201, a processor 202, a persistent storage device 203, and a network connection 204. The memory 201 may be used for storing programs and data while they are being used, including data associated with the MDU content presentation system, content presentation devices, user device, access points, other devices, an organization, an operating system including a kernel (not shown), device drivers (not shown), and one or more machine learning models. The processor 202 may be used for executing computer programs (not shown), such as computer programs which perform some or all of the functions of the system. In some embodiments, the processor 202 may be one or more processors, microcontrollers, or other computer components. In some embodiments, any of the processors, microcontrollers, or other computer components, either alone or in combination, can perform any of the functions or acts described herein. The persistent storage device 203 may be a hard drive or flash drive for persistently storing programs and data. The network connection 204 may be used for connecting to one or more access points, devices, content presentation devices, or other computer systems (not shown), to send or receive data, such as via the Internet or another network and associated networking hardware, such as switches, routers, repeaters, electrical cables and optical fibers, light emitters and receivers, radio transmitters and receivers, and the like, and to scan for and retrieve signals associated with content presentation devices, user devices, other devices, an MDU content presentation system, and for connecting to one or more computer devices such as content presentation devices, a user device, a MDU content presentation system, other devices or components associated with an organization associated with the MDU content presentation system, or other computer systems. In various embodiments, the system 200 additionally includes input and output devices, such as a keyboard, a mouse, display devices, etc.

While a system 200 configured as described may be used in some embodiments, in various other embodiments, the system 200 may be implemented using devices of various types and configurations and having various components. The memory 201 may include a content presentation controller 210, which contains computer-executable instructions that, when executed by the CPU 202, cause the system 200 to perform the operations and functions described herein. For example, the programs referenced above, which may be stored in computer memory 201, may include or be comprised of such computer-executable instructions.

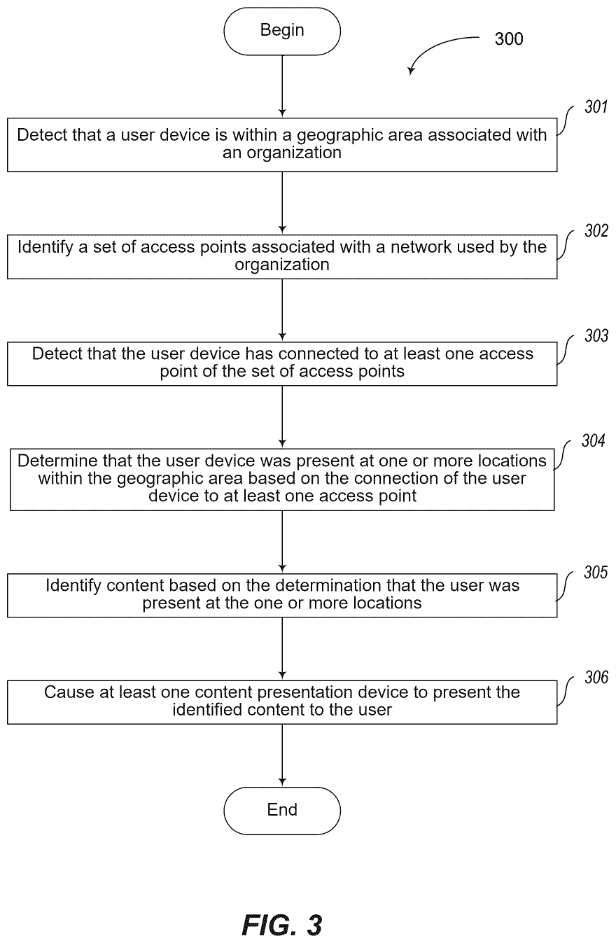

The content presentation controller 210 (the “controller 210”) performs the core functions of the system 200, as discussed herein and also with respect to FIGS. 3-6. In particular, the controller 210 detects that a user device is within a geographic area associated with an organization and detects whether the user device has connected to at least one access point associated with the organization. Additionally, the controller 210 may determine whether a user of the user device was present at one or more locations based on the connection of the user device to the at least one access point. The controller 210 may use such a determination to identify content to present to the user, and may cause a content presentation device to present the identified content to the user. The controller 210 may also perform other functions related to the functions of the system 200 described herein.

In an example embodiment, the controller 210 or computer-executable instructions stored on memory 201 of the system 200 are implemented using standard programming techniques. For example, the controller 210 or computer-executable instructions stored on memory 201 of the system 200 may be implemented as a “native” executable running on CPU 202, along with one or more static or dynamic libraries. In other embodiments, the controller 210 or computer-executable instructions stored on memory 201 of the system 200 may be implemented as instructions processed by a virtual machine that executes as some other program.

The embodiments described above may also use synchronous or asynchronous client-server computing techniques. However, the various components may be implemented using more monolithic programming techniques as well, for example, as an executable running on a single processor computer system, or alternatively decomposed using a variety of structuring techniques known in the art, including but not limited to, multiprogramming, multithreading, client-server, or peer-to-peer, running on one or more computer systems each having one or more processors. Some embodiments may execute concurrently and asynchronously, and communicate using message passing techniques. Equivalent synchronous embodiments are also supported. Also, other functions could be implemented or performed by each component/module, and in different orders, and by different components/modules, yet still achieve the functions of the controller 200.

In addition, programming interfaces to the data stored as part of the controller 210 can be available by standard mechanisms such as through C, C++, C#, Java, and web APIs; libraries for accessing files, databases, or other data repositories; through scripting languages such as JavaScript and VBScript; or through Web servers, FTP servers, or other types of servers providing access to stored data. The controller 210 may be implemented by using one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions of the system 200.

Furthermore, in some embodiments, some or all of the components/portions of the controller 210, or functionality provided by the computer-executable instructions stored on memory 201 of the system 200 may be implemented or provided in other manners, such as at least partially in firmware or hardware, including, but not limited to, one or more application-specific integrated circuits (ASICs), standard integrated circuits, controllers (e.g., by executing appropriate instructions, and including microcontrollers or embedded controllers), field-programmable gate arrays (FPGAs), complex programmable logic devices (CPLDs), and the like. Some or all of the system components or data structures may also be stored as contents (e.g., as executable or other machine-readable software instructions or structured data) on a computer-readable medium (e.g., as a hard disk; a memory; a computer network or cellular wireless network; or a portable media article to be read by an appropriate drive or via an appropriate connection, such as a DVD or flash memory device) so as to enable or configure the computer-readable medium or one or more associated computing systems or devices to execute or otherwise use or provide the contents to perform at least some of the described techniques. Such computer program products may also take other forms in other embodiments. Accordingly, embodiments of this disclosure may be practiced with other computer system configurations.

In general, a range of programming languages may be employed for implementing any of the functionality of the content presentation devices; system 200; systems, applications, and functions, of the organization; etc., present in the example embodiments, including representative implementations of various programming language paradigms and platforms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, PHP, Python, JavaScript, VBScript, and the like) and declarative (e.g., SQL, Prolog, and the like).

In some embodiments, aspects of the system 200 may be implemented in an application executed by a user device, content presentation device, access point, other computing device, or some combination thereof. In some such embodiments, some of the functions of the system 200, such as detecting whether the user device is within a geographic area associated with an organization, identifying access points associated with the organization, determining whether a user device was present at one or more locations based on the connection of the user device to one or more access points, identifying content based on one or more locations at which the user device was present, causing the at least one content presentation device to present the identified content to the user, causing one or more devices to be configured based on historical data associated with the user, causing content to be displayed to a user based on historical data indicating that the user previously viewed at least a portion of the content, or other functions of the system 200, may be performed by a computing device via execution of the application.

The operation of certain aspects will now be described with respect to FIGS. 3-6. In at least one of various embodiments, at least a portion of the processes 300, 400, 500, and 600 described in conjunction with FIGS. 3, 4, 5, and 6, respectively, may be implemented by one or more processors or executed via circuitry on one or more computing devices described in connection with FIG. 2, the content presentation devices 107 described in connection with FIG. 1, user device 103, access points 101, other computing devices, or some combination thereof.

Furthermore, aspects of the processes 300-600 may cause a content presentation device, the system 200, user device, another computing device, or some combination thereof to take an action, such as receiving data, displaying certain data, altering the display of data, transmitting data, other actions, or some combination thereof. In some embodiments, causing a content presentation device, the system 200, a user device, an access point, or another device to take an action includes transmitting instructions to take the action to the content presentation device, the system 200, a user device, an access point, or other device, such as by transmitting instructions from the system or device to another system or device.

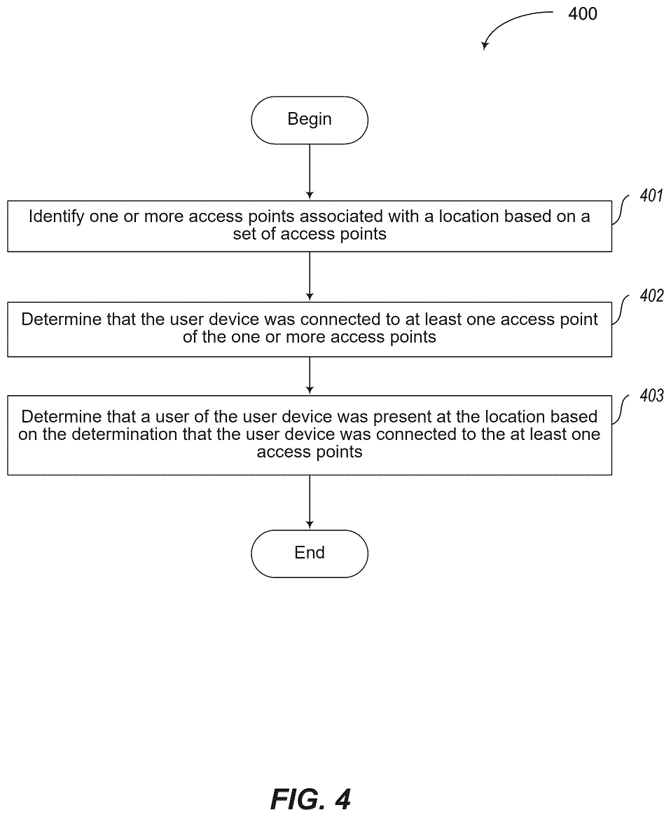

FIG. 3 is a flow diagram of a process 300 for presenting content to a user, according to various embodiments described herein. Any of the aspects of the process 300 may be performed by a content presentation system, such as the system 200 described above with respect to FIGS. 1 and 2, a content presentation device, a user device, an access point, another device or system, or some combination thereof. In some embodiments, as part of performing the acts included in the process 300, the system performs one or more of the acts included in the processes 400, 500, 600, or some combination thereof, described below in connection with FIGS. 4, 5, and 6.

The process 300 begins at act 301, where the system 200 detects that a user device is within a geographic area associated with an organization. In some embodiments, the system 200 detects that the user device is within the geographic area based on a determination that the user device has connected to an access point associated with the organization and in that particular geographic area. In some embodiments, the system 200 detects that the user device is within the geographic area based on a determination that the user device has scanned a physical code. In some embodiments, the geographic area may include a building associated with the organization, such as a hotel, restaurant, café, motel, apartment building, condo building, or other type of building. In some embodiments, the geographic area may include a vehicle associated with the organization, such as an airplane, a boat, a car, a train, or another type of vehicle. In some embodiments, the system determines whether the user device has transmitted data to or received data from a device associated with the organization. In some embodiments, the device associated with the organization may include a near-field communication (NFC) chip, a Bluetooth transceiver, access to other short-range wireless communication equipment, or some combination thereof.

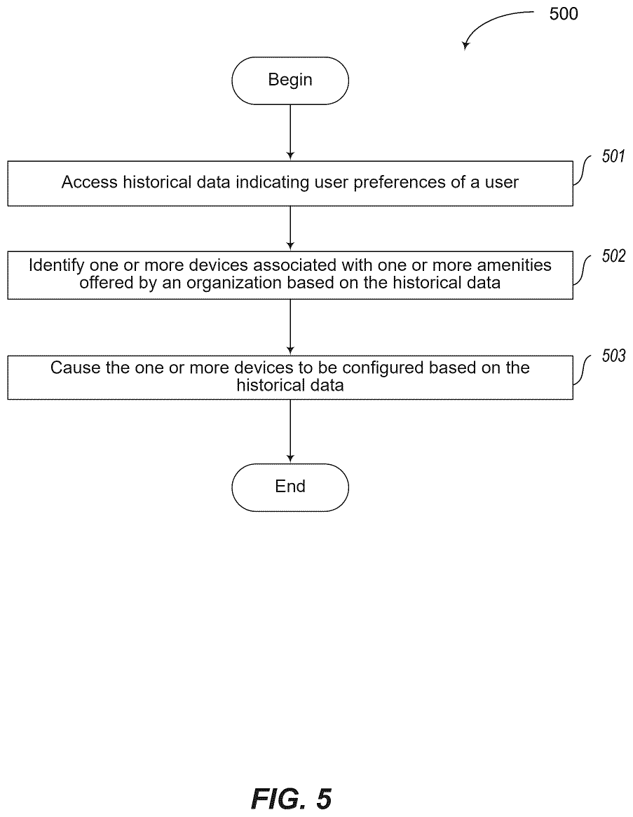

In some embodiments, at act 301, the system 200 may configure one or more devices based on historical user data based on a detection by the system 200 that the user device is within the geographic area associated with the organization, such as by using the process 500 described below in connection with FIG. 5. For example, if the organization is a hotel, the system 200 may configure one or more devices included in a hotel room assigned to the user of the user device based on the detection that the user device is within the geographic area associated with the organization.

The process 300 proceeds to act 302, where the system 200 identifies a set of access points associated with a network used by the organization. In some embodiments, each of the access points are associated with an area within the geographic area. For example, if the organization is a hotel, the access points may be associated with the front desk, restaurant, one or more rooms, a gym, a spa, other amenities or rooms that may be provided in a hotel, or some combination thereof.

The process 300 proceeds to act 303, where the system 200 detects that the user device has connected to at least one access point of the set of access points. In some embodiments, the system 200 stores data indicating one or more access points to which the user device was connected. In some embodiments, at least one access point is within the geographic area.

The process 300 proceeds to act 304, where the system 200 determines that the user device was present at one or more locations within the geographic area based on the connection of the user device to at least one access point. In some embodiments, the system uses the process 400, described below in connection with FIG. 4, to determine that a user device was present at one or more locations within the geographic area. In some embodiments, the one or more locations may be areas, such as the areas 105 described above in connection with FIG. 1. In some embodiments, at act 304, the system 200 may configure one or more devices included in the one or more locations based on historical user data based on a detection by the system 200 that the user device is within the geographic area associated with the organization.

The process 300 proceeds to act 305, where the system 200 identifies content based on the determination that the user device was present at the one or more locations. In some embodiments, the content is content associated with one or more amenities provided by the organization in the one or more locations or areas. For example, the content may be content including information regarding the one or more locations or areas. In some embodiments, the content may be identified based on the determination that the user device was present at one or more locations or areas and other data used to identify content for the user, such as data regarding the user's content consumption, data regarding the user's content preferences, data regarding demographic information of the user, data regarding locations or areas that the user has visited in the past, other data associated with the user or user device, or some combination thereof.

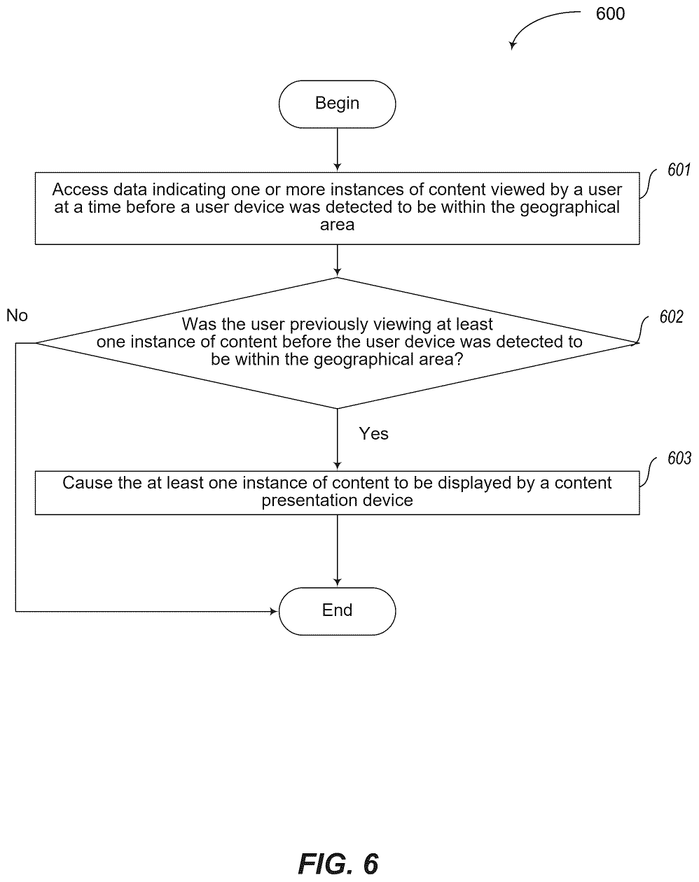

In some embodiments, at act 305, the system 200 may identify content based on a determination that the user previously viewed the content, such as by using the process 600 described below in connection with FIG. 6. For example, if the organization provides the user with access to a content presentation device, the system 200 may cause the content presentation device to resume playing content previously viewed by the user.

The process 300 proceeds to act 306, where the system 200 causes at least one content presentation device to present the identified content to the user. In some embodiments, the system 200 causes the user device to present the identified content to the user. In some embodiments, the system determines whether the user device is connected to an access point associated with one or more amenities provided by the organization. In such embodiments, the system may cause a content presentation device associated with an amenity associated with the access point to display the content.

After act 306, the process 300 ends.

FIG. 4 is a flow diagram of a process 400 for determining whether a user device was present in one or more geographic areas, according to various embodiments described herein. Any of the aspects of the process 400 may be performed by a content presentation system, such as the system 200 described above with respect to FIGS. 1 and 2, a content presentation device, a user device, an access point, another device or system, or some combination thereof.

The process 400 begins, after a start block, at act 401, where the system identifies one or more access points associated with a location based on a set of access points. In some embodiments, data indicating the set of access points includes data describing one or more locations or areas (collectively “areas”) to which one or more access points are associated.

The process 400 proceeds to act 402, where the system determines that the user device was connected to at least one access point of the one or more access points. In some embodiments, the system determines that the user device was connected to an access point based on information received from the access point indicating one or more devices connected to the access point.

The process 400 proceeds to act 403, where the system determines that a user of the user device was present at the location based on the determination that the user device was connected to the at least one access point. In such embodiments, the system may make the determination based on an indication of one or more areas associated with the at least one access point.

After act 403, the process 400 ends.

FIG. 5 is a flow diagram of a process 500 to configure one or more devices based on historical user data, according to various embodiments described herein. Any of the aspects of the process 500 may be performed by a content presentation system, such as the system 200 described above with respect to FIGS. 1 and 2, a content presentation device, a user device, an access point, another device or system, or some combination thereof.

The process 500 begins, after a start block, at act 501, where the system accesses historical data indicating user preferences of a user. In some embodiments, the historical data indicating user preferences may include data describing one or more configurations of one or more smart devices associated with the user, content viewed by the user, one or more configurations of one or more content presentation devices associated with the user, other data that may indicate a user preference, or some combination thereof. In some embodiments, the historical data includes data associated with a user profile created for a user by the system. In some embodiments, the user profile is a profile associated with an organization that manages, controls, creates, or is otherwise associated with the system, such as a telecommunications service provider, a cable service provider, an internet service provider, another type of service provider, or some combination thereof. In some embodiments, the user profile may be created based on input received from a user device. In such embodiments, the system may cause the user device to prompt the user to provide the input in response to detecting that the user device is within the geographical area associated with the organization. In some embodiments, the historical data is generated based on configuration data for one or more devices associated with the user, such as configuration data for one or more smart devices, one or more content presentation devices, one or more user devices, one or more other devices, or some combination thereof.

The process 500 proceeds to act 502, where the system identifies one or more devices associated with one or more amenities offered by an organization based on the historical data. In some embodiments, the one or more devices include smart devices, content presentation devices, other devices, or some combination thereof. In some embodiments, the system identifies the one or more devices based on a determination that the one or more devices can be configured based on user preferences included in the historical data.

The process 500 proceeds to act 503, where the system causes the one or more devices to be configured based on the historical data. In some embodiments, the system causes the one or more devices to be configured by transmitting instructions to the one or more devices to log a user profile in to at least one account associated with at least one service used by the one or more devices. For example, the system may cause a user account associated with a streaming service to be logged in to a content presentation device. In some embodiments, the system causes the one or more devices to be configured by transmitting instructions to the one or more devices to apply one or more configuration settings identified in the historical data. For example, the system may cause instructions to be transmitted to a smart thermostat that include configuration settings of a smart thermostat associated with the user. As another example, the system may cause instructions to be transmitted to a content presentation device that include configuration settings of a content presentation device associated with the user, such as volume settings, display settings, or other settings associated with a presentation device.

The process 500 ends after act 503.

FIG. 6 is a flow diagram of a process 600 to display content previously viewed by a user on a content presentation device, according to various embodiments described herein. Any of the aspects of the process 600 may be performed by a content presentation system, such as the system 200 described above with respect to FIGS. 1 and 2, a content presentation device, a user device, an access point, another device or system, or some combination thereof.

The process 600 begins, after a start block, at act 601, where the system accesses data indicating one or more instances of content viewed by a user at a time before the user device was detected to be within the geographical area. In some embodiments, the data indicates that the user accessed the content without viewing, hearing, or otherwise consuming, the entirety of the content. In some embodiments, the content may be a movie, television show, song, podcast, audiobook, other content, or some combination thereof.

The process 600 proceeds to act 602, where the system determines whether the user was previously viewing at least one instance of content before the user device was detected to be within the geographical area. In some embodiments, the system determines whether the user was previously viewing at least one instance of content before the user device was detected to be within the geographical area based on the accessed data indicating one or more instance of content viewed by the user. If the user was previously viewing at least one instance of content before the user device as detected to be within the geographical area, the process 600 proceeds to act 603, otherwise, the process 600 ends.

At act 603, the system causes the at least one instance of content to be displayed by a content presentation device. In some embodiments, the system performs act 603 in a similar manner to act 306.

After act 603, the process 600 ends.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system comprising:
at least one processor; and
at least one non-transitory processor-readable storage medium storing instructions or data thereon, the instructions or data, when executed by the at least one processor, cause the at least one processor to:
detect that a user device for a user is within a geographic area associated with an organization;
identify a set of access points associated with a network used by the organization;
detect whether the user device has connected to at least one access point of the set of access points;
determine whether the user of the user device was present at one or more locations within the geographic area based on the connection of the user device to the at least one access point;
identify content based on the determination of whether the user was present at the one or more locations; and
cause at least one content presentation device to present the identified content to the user.

2. The system of claim 1, wherein, to cause the at least one content presentation device to present the identified content to the user, the instructions or data further cause the at least one processor to:
cause the user device to present the identified content to the user.

3. The system of claim 1, wherein, to cause the at least one content presentation device to present the identified content to the user, the instructions or data further cause the at least one processor to:
cause a content presentation device associated with the organization to present the identified content to the user.

4. The system of claim 1, wherein, to determine whether the user of the user device was present at one or more locations within the geographic area, the instructions or data further cause the at least one processor to:
for each respective location of the one or more locations:
identify one or more access points associated with the respective location based on the set of access points;
determine whether the user device was connected to at least one access point of the one or more access points; and
determine that the user was present at the respective location based on the determination that the user device was connected to the at least one access point.

5. The system of claim 1, wherein the instructions or data further cause the at least one processor to:
access historical data indicating one or more user preferences of the user;
identify one or more devices associated with one or more amenities offered by the organization based on the historical data; and
cause the one or more devices to be configured based on the historical data indicating the one or more user preferences of the user.

6. The system of claim 5, wherein, to cause the one or more devices to be configured, the instructions or data further cause the at least one processor to:
identify whether at least one device associated with one or more amenities is connected to the network; and
identify one or more user preferences that can be used to configure the at least one device based on the at least one device and the historical data indicating user preferences; and
transmit a signal to the at least one device instructing the at least one device to be configured based on the historical data indicating user preferences.

7. The system of claim 5, wherein the instructions or data further cause the at least one processor to:
identify one or more smart devices associated with the user;
identify one or more configurations of the one or more smart devices; and
generate historical data indicating user preferences based on the one or more configurations.

8. The system of claim 1, wherein, to detect that the user device associated with the user is within a geographic area associated with an organization, the instructions or data further cause the at least one processor to:
determine whether the user device has connected to one or more access points of the set of access points.

9. The system of claim 1, wherein, to detect that the user device associated with the user is within a geographic area associated with an organization, the instructions or data further cause the at least one processor to:
determine whether the user device has scanned one or more physical codes associated with the organization.

10. The system of claim 1, wherein, to detect that the user device associated with the user is within a geographic area associated with an organization, the instructions or data further cause the at least one processor to:
determine whether the user device has transmitted data to a device equipped with a near-field-communication (NFC) chip.

11. The system of claim 1, wherein the instructions or data further cause the at least one processor to:
access data indicating one or more instances of content viewed by the user at a time before the user device was detected to be within the geographical area;
determine whether the user was previously viewing at least one instance content before the user device was detected to be within the geographical area based on the data indicating one or more instances of content viewed by the user; and
cause the at least one instance of content to be displayed by the at least one content presentation device based on a determination that the user was previously viewing the at least one instance of content before the user device was detected to be within the geographical area.

12. The system of claim 11, wherein, to cause the at least one instance of content to be displayed by a content presentation device, the instructions or data further cause the at least one processor to:
determine whether the user device has connected to an access point associated with one or more amenities provided by the organization; and
cause a content presentation device associated with the one or more amenities to receive instructions to display the content based on a determination that the user device has connected to the access point associated with the one or more amenities.

13. A non-transitory processor-readable storage medium that stores at least one of instructions or data, the instructions or data, when executed by at least one processor, cause the at least one processor to perform a method comprising:
detecting that a user device for a user is within a geographic area associated with an organization;
identifying a set of access points associated with a network used by the organization;
detecting that the user device has connected to at least one access point of the set of access points;
determining that the user of the user device was present at one or more locations within the geographic area based on the connection of the user device to the at least one access point;
identifying content based on the determination of whether the user was present at the one or more locations; and
causing at least one content presentation device to present the identified content to the user.

14. The non-transitory processor-readable storage medium of claim 13, wherein determining that the user of the user device was present at one or more locations within the geographic area further comprises:
for each respective location of the one or more locations:
identifying one or more access points associated with the respective location based on the set of access points;
determining whether the user device was connected to at least one access point of the one or more access points; and
determining that the user was present at the respective location based on the determination that the user device was connected to the at least one access point.

15. The non-transitory processor-readable storage medium of claim 13, wherein the method further comprises:
accessing historical data indicating one or more user preferences of the user;
identifying one or more devices associated with one or more amenities offered by the organization based on the historical data; and
causing the one or more devices to be configured based on the historical data indicating the one or more user preferences of the user.

16. The non-transitory processor-readable storage medium of claim 13, the method further comprises:
accessing data indicating one or more instances of content viewed by the user at a time before the user device was detected to be within the geographical area;
determining whether the user was previously viewing at least one instance content before the user device was detected to be within the geographical area based on the data indicating one or more instances of content viewed by the user; and
causing the at least one instance of content to be displayed by the at least one content presentation device based on a determination that the user was previously viewing the at least one instance of content before the user device was detected to be within the geographical area.

17. A method comprising:
detecting that a user device for a user is within a geographic area associated with an organization;
identifying a set of access points associated with a network used by the organization;
detecting that the user device has connected to at least one access point of the set of access points;
determining that the user of the user device was present at one or more locations within the geographic area based on the connection of the user device to the at least one access point;
identifying content based on the determination of whether the user was present at the one or more locations; and
causing at least one content presentation device to present the identified content to the user.

18. The method of claim 17, wherein determining that the user of the user device was present at one or more locations within the geographic area further comprises:
for each respective location of the one or more locations:
identifying one or more access points associated with the respective location based on the set of access points;
determining whether the user device was connected to at least one access point of the one or more access points; and
determining that the user was present at the respective location based on the determination that the user device was connected to the at least one access point.

19. The method of claim 17, wherein the method further comprises:
accessing historical data indicating one or more user preferences of the user;
identifying one or more devices associated with one or more amenities offered by the organization based on the historical data; and
causing the one or more devices to be configured based on the historical data indicating the one or more user preferences of the user.

20. The method of claim 17, the method further comprises:
accessing data indicating one or more instances of content viewed by the user at a time before the user device was detected to be within the geographical area;
determining whether the user was previously viewing at least one instance content before the user device was detected to be within the geographical area based on the data indicating one or more instances of content viewed by the user; and
causing the at least one instance of content to be displayed by the at least one content presentation device based on a determination that the user was previously viewing the at least one instance of content before the user device was detected to be within the geographical area.
